(19) United States
(12) Patent Application Publication
(10) Pub. No.: US 2022/0335733 A1
(43) Pub. Date: Oct. 20, 2022

(54) IMPROVEMENTS IN OR RELATING TO PHOTOGRAMMETRY

(71) Applicant: University of Nottingham, Nottingham (GB)

(72) Inventors: Richard Leach, Nottingham (GB); Samanta Piano, Nottingham (GB); Danny Sims-Waterhouse, Nottingham (GB)

(73) Assignee: University of Nottingham, Nottingham (GB)

(21) Appl. No.: 17/631,383

(22) PCT Filed: Jul. 21, 2020
(86) PCT No.: PCT/GB2020/051733

§ 371 Date: Jan. 28, 2022

(30) Foreign Application Priority Data
Jul. 30, 2019 (GB) 1910848.9

(51) Int. Cl. G06V 20/64; G01C 11/02; G06T 7/73

(52) U.S. Cl. CPC G06V 20/64; G01C 11/02; G06T 7/73; G06T 2207/10028

(57) ABSTRACT

Photogrammetric analysis of an object is carried out by capturing images of the object. Photogrammetric analysis requires the capture of multiple overlapping images of the object from various camera positions. These images are then processed to generate a three-dimensional (3D) point cloud representing the object in 3D space. A 3D model of the object is used to generate a model 3D point cloud. Based on the modelled point cloud and camera optics, the visibility of each point in the 3D point cloud is determined for a range of possible camera positions. The radial component of the camera is fixed by defining a shell of suitable camera positions around the part and for each position on the defined shell, the quality as a function of camera position is calculated. This defines a density function over the potential camera positions. Initial camera positions are selected based on the density function.

### TECHNICAL FIELD OF THE INVENTION

The present invention relates to defect analysis in manufacturing processes using photogrammetry. In particular, the present invention relates to determination of the optimum photogrammetry photography positions for a particular object.

### BACKGROUND TO THE INVENTION

Photogrammetry is the technique of analysing an image or images in order to measure the properties of objects captured in those images. One important application of photogrammetry is to determine a three-dimensional (3D) point cloud that represents an object's shape and size. This can be very useful in manufacturing processes as it allows the quality of a manufactured object to be assessed by comparison with the original design.

The typical photogrammetric process involves first capturing many overlapping images of the object. These images are then processed to identify features that are invariant to effects such as scale and rotation. Correspondence between the features in different images is then used to generate a sparse cloud of points representing the object in 3D space. Finally, the sparse cloud is then used to generate a much denser cloud suitable for the desired application such as defect analysis.

Typically the images are captured by a camera, the number of captured images and the position of the camera for the captured images being determined manually by the camera operator. This is unsatisfactory as operator errors or deficiencies in terms of skill and experience can lead to significant reductions in the efficiency of the photogrammetry process. For example, the operator may capture more images than necessary for accurate analysis, wasting time and effort in capturing said images and computing resources in processing the images. Alternatively, the operator may not capture sufficient images of the object as a whole or of specific features of the object. This can lead to generation of a poor-quality 3D point cloud and inaccurate analysis.

It is therefore an object of the present invention to provide an automated process that at least partially overcomes or alleviates the above issues.

### SUMMARY OF THE INVENTION

According to a first aspect of the present invention there is provided a method of determining optimum camera positions for capturing images of an object for photogrammetry analysis, the method comprising the steps of: providing a three-dimensional (3D) model of the object; generating a model 3D point cloud from the 3D model; defining a radial shell of possible camera positions around the model 3D point cloud; calculating a quality parameter for the possible camera position; selecting a number of camera positions from the possible camera positions in response to the calculated quality parameter.

The present invention thus enables the efficient automated selection of optimum camera positions for use in photogrammetry analysis. This removes the need for a human operator to choose camera positions thereby limiting the potential negative impact of an inexperienced operator. Furthermore, the method of the present invention allows an operator to balance time and accuracy in photogrammetry analysis processes more effectively

The method may include the step of providing a model of the camera optics. This can enable accurate calculation of the visibility of points from each camera position. The method may include the step of providing a model of the achievable range of motion of the camera. This can be used to exclude from processing camera positions that are not achievable in practice.

The shell radius may be preset or may be selected. In the event the shell radius is selected, it may be selected so as to maximise the number of points on the sample surface that are in focus. In some embodiments, the method may utilise more than one shell. This can be beneficial where the camera has a low depth of field.

The number of camera positions selected may be preset. In such cases, the number of positions selected may be determined based on available scan time and/or acceptable geometric tolerance.

The quality parameter may be calculated by a quality function. The quality function may comprise a summation of one or more calculated terms. The summation may be a weighted summation. The calculated terms may involve calculation of an uncertainty parameter uncert(θ, α, n). The uncertainty parameter for a point n may be calculated from

uncert(θ,α,n)=vis(θ,α,n)×(\vec{ray}(θ,α,n)·\vec{norm}(θ,α,n))

where θ is the azimuth, α is the elevation, \vec{ray}(θ, α, n) is normalised ray vector from the camera to point n, \vec{norm}(θ, α, n) is the surface normal of point n and vis (θ, α, n) is a logical visibility matrix.

In such embodiments, one calculated term may be an accuracy parameter. the accuracy parameter may quantify the accuracy to which the visible points can be localised. The accuracy parameter is at a minimum when the surface is parallel to the optical axis and maximised when the surface is normal to the optical axis. The accuracy parameter may be calculated from

$${\sum }_{n = 1}^{N} uncert ( θ , α , n )$$

where N is the number of points.

In such embodiments, another calculated term may be an occlusion parameter. the occlusion parameter may quantify the rate at which points become occluded. The occlusion parameter therefore can ensure that points are captured prior to the point going out of view. The occlusion parameter may be calculated from

$${\sum }_{n = 1}^{N} ( \frac{δ}{δ θ} ( \frac{δ}{δ α} ( uncert ( θ , α , n ) ) ) * Gaussian ( γ , σ ) ) \times vis ( θ , α , n )$$

where Gaussian(γ, σ) is a gaussian function at radius γ with width σ.

In one embodiment the quality function may comprise a weighted sum of the accuracy parameter and the occlusion parameter. In such an embodiment the quality function used for calculating the quality parameter (Quality(θ, a)) may be defined by

$$Quality ( θ , α ) = {w}_{1} {\sum }_{n = 1}^{N} uncert ( θ , α , n ) + {w}_{2} {\sum }_{n = 1}^{N} ( \frac{δ}{δ θ} ( \frac{δ}{δ α} ( uncert ( θ , α , n ) ) ) * Gaussian ( γ , σ ) ) \times vis ( θ , α , n )$$

Where w₁ and w₂ are weighting variables. The weighting variables may be preset.

In some embodiments, the quality function may include one or more additional terms. Such terms may include but are not limited to: point weighting based on importance of being captured; distance of each point from the camera focal plane and a term to ensure there is a small enough angle between cameras to ensure good feature matching.

In some embodiments, the method may include the step of selecting initial camera positions using the quality function and subsequently carrying out optimisation analysis to select optimum camera positions. In such embodiments, the quality parameter may define a density function over the potential camera positions. The density function may be used as a probability distribution to aid selection of initial camera positions.

The optimisation analysis may be carried out by optimising a cost function. The cost function may comprise a sum of one or more calculated terms. The sum may be a weighted sum.

In such embodiments, one calculated term may be a quality term. The quality term may be based on the quality parameter. The quality term may be calculated from

$${\sum }_{k = 1}^{K} {Quality ( {θ}_{k} , {α}_{k} )}^{- 1}$$

where K is the number of cameras.

Another calculated term may be a minimum visibility term. The minimum visibility term may be derived from a requirement for each point to be visible to a minimum number of selected camera positions. The minimum visibility term may be calculated from

$${\sum }_{n = 1}^{N} MinVis ( n )$$

where is MinVis(n) a minimum visibility parameter. The minimum visibility parameter may be defined by:

$$MinVis ( n ) = \{ \begin{matrix}1 , & {\sum }_{k = 1}^{K} vis ( {θ}_{k} , {α}_{k} , n ) < reqView \\ 0 , & {\sum }_{k = 1}^{K} vis ( {θ}_{k} , {α}_{k} , n ) \geq reqView\end{matrix}$$

where reqView is the minimum number of camera positions from which each point must be visible.

A further calculated term may be a triangulation term. The triangulation term may quantify the maximum angle between camera positions in which a point is visible. The triangulation term may be calculated from

$$Triang ( n ) = {\sum }_{k = 1}^{K - 1} {\sum }_{l = k + 1}^{K} ( \vec{ray} ( {θ}_{k} , {α}_{k} , n ) \cdot \vec{ray} ( {θ}_{l} , {α}_{l} , n ) ) \times common ( k , l , n )$$

Where common(k, l, n) is a triangular logical matrix which is 1 when point n is visible in both cameras k and l. The triangular logical matrix may be calculated from

common(k,l,n)=vis(θₖ,αₖ,n)·vis(ƒₗ,αₗ,n)

In one embodiment the cost function may comprise a weighted sum of the quality term, the minimum visibility term and the triangulation term. In such an embodiment the cost function may be defined by

$$Cost = {c}_{1} {\sum }_{k = 1}^{K} {Quality ( {θ}_{k} , {α}_{k} )}^{- 1} + {c}_{2} {\sum }_{n = 1}^{N} MinVis ( n ) + {c}_{3} {\sum }_{n = 1}^{N} Triang ( n )$$

where c₁, c₂ and c₃ are weighting variables. The weighting variables may be preset.

In some embodiments, the cost function may include one or more additional terms.

In one embodiment, the optimisation analysis may be carried out with respect to a temporal budget. The temporal budget may be defined by the maximum scan time or reconstruction time available for photogrammetric analysis. The temporal budget will effectively define the maximum number of images of the object that can be captured during the analysis. The temporal budget may be preset or may be selected.

Temporal budget optimisation analysis may include the step of selecting a number of initial camera positions and refining the initial camera positions by minimisation of the cost function. This allows scan accuracy to be maximised for the allowed number of images. The number of cameras may be selected or may be preset. The selection of initial camera positions may be carried out in response to the quality parameter calculation.

In one embodiment, the optimisation analysis may be carried out with respect to a geometric budget. The geometric budget may be defined by the level of accuracy required from the photogrammetric analysis.

Geometric budget optimisation analysis may include the step of determining the proportion of points n that meet or exceed accuracy criteria. The accuracy criteria may be calculated using the minimum visibility parameter and/or the triangulation parameter. In one implementation, the accuracy criteria may be satisfied by points where

$$\frac{1}{N} {\sum }_{n = 1}^{N} MinVis ( n ) < Threshold \% ,$$

where Threshold % is the threshold for non-visible points.

In another implementation, the accuracy criteria may be satisfied by points where

$$\frac{1}{N} {\sum }_{n = 1}^{N} ( Triang ( n ) > ω )$$

where ω is a threshold value. The threshold value ω may be determined by a computational model of the photogrammetry system and/or the model of the camera optics. In particular, the threshold value may correspond to the Triang (n)value required to reach the predetermined level of accuracy.

According to a second aspect of the present invention there is provided a photogrammetry apparatus comprising: one or more cameras, each camera provided on a movable mounting bracket; an analysis engine operable to conduct photographic analysis of images captured by the or each camera; and a camera position engine operable to calculate optimum camera positions for capturing images of an object for photogrammetry analysis, the camera position engine operable according to the method of the first aspect of the present invention.

The apparatus of the second aspect of the present invention may incorporate any or all features of the method of the first aspect of the invention, as required or as desired.

### DETAILED DESCRIPTION OF THE INVENTION

In order that the invention may be more clearly understood one or more embodiments thereof will now be described, by way of example only, with reference to the accompanying drawings, of which:

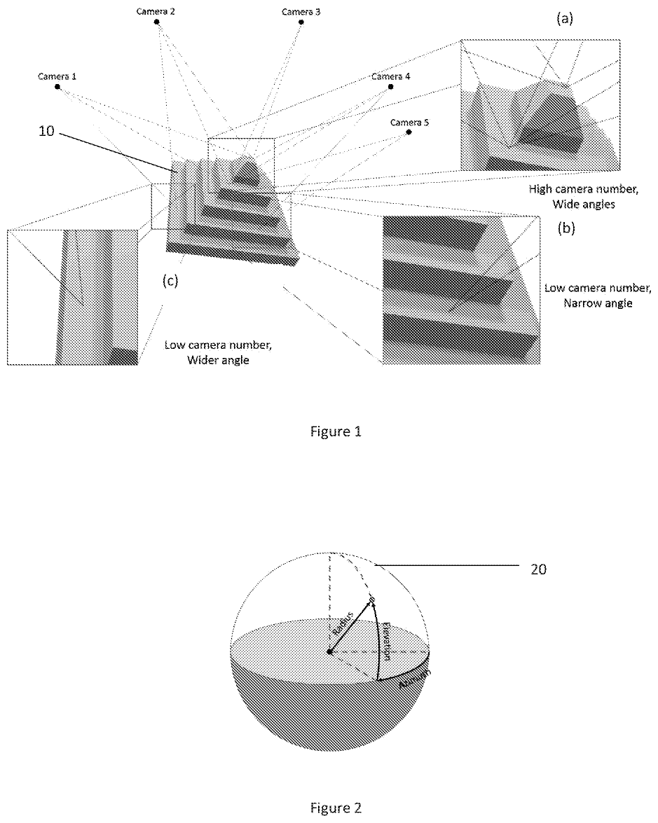

FIG. 1 is a schematic representation of an object subject to photogrammetric analysis; and

FIG. 2 is a schematic representation of a shell of possible camera positions for carrying out photogrammetric analysis of the object of FIG. 1.

Turning now to FIG. 1, photogrammetric analysis of an object 10 is carried out by capturing images of the object 10 from a number of possible camera positions exemplified by positions 1-5. Photogrammetric analysis requires the capture of multiple overlapping images of the object 10. These images are then processed to generate a three-dimensional (3D) point cloud representing the object in 3D space. In order to generate an accurate point cloud, care must be taken to select appropriate camera positions so that images of all the features of object 10 can be captured. Depending upon the nature of particular object features, different image properties may be required. For instance: inset (a) of FIG. 1 illustrates a feature captured by a high number of cameras at wide angles; inset (b) illustrates a feature captured by a low number of cameras at narrow angles; and inset (c) illustrates a feature captured by a low number of cameras at wide angles.

The present invention is directed to a method of determining optimum camera positions for capturing images of an object for generation of a 3D point cloud for photogrammetry analysis. This allows automation of the camera position determination. This is more efficient and accurate than manual position selection by an operator. It can also be tailored to ensure an appropriate level of accuracy and/or to conform to a desired maximum scan time.

In the method, the first step is to provide a 3D model of the object. Typically, this can be achieved by using STL/CAD data. The STL/CAD information is used to generate a model 3D point cloud in order to accelerate the calculations discussed in the coming steps. The density of the 3D point cloud will affect the speed and accuracy of the algorithm (higher density is more accurate but slower).

In addition, the properties of the camera optics and the permitted range of motion of the cameras are provided. For the sake of simplicity, the latter steps assume a single photogrammetry system able to move through a range of radii on a spherical polar coordinate system, the positions defined by radius, elevation (a) and azimuth (0) as shown in FIG. 2. However, this methodology can be applied to any camera-based measurement system.

Based on the modelled point cloud and camera optics, the visibility of each point in the 3D point cloud is determined for a range of possible camera positions. This calculation can take into account both line-of-sight visibility and depth-of-field, requiring each point to be both visible and in focus.

In order to substantially reduce the complexity of the problem, the radial component of the camera is fixed by defining a shell 20 of suitable camera positions around the part that will maximise the visible number of points according to the focal plane of the camera. In other words, for each elevation and azimuth, this process will define a radius in which the maximum number of points on the object surface are in focus. For systems with a particularly low depth-of-field, multiple shells may be defined in order to cover the entirety of the object.

For each elevation and azimuth on the defined shell, a quality parameter is calculated from a quality function in order to quantify how important is the camera position. The quality parameter relates to the likely quality of images captured at each potential camera position. The quality is higher when the image will contribute more to accurate photogrammetric reconstruction of the object. The quality as a function of camera position is calculated and this defines a density function over the potential camera positions.

The density function is used as a probability distribution to select initial camera positions. The number of camera positions required is set by the chosen scan time (lower scan time requires fewer camera positions) or based on the required accuracy (greater accuracy requires more camera positions). The initial camera positions are selected based on the density function. The initial positions are then subject to refinement by optimisation analysis. This analysis is carried out by minimising a cost function which is based on the overall expected quality of the photogrammetric analysis from images captured from the selected camera positions. The process can be repeated for different numbers of camera positions so that the optimum balance of time and accuracy is achieved.

Turning to the quality function, this comprises a weighted sum of calculated terms defining an accuracy parameter and an occlusion parameter. In the particular example discussed herein, the quality function takes the form:

$$Quality ( θ , α ) = {w}_{1} {\sum }_{n = 1}^{N} uncert ( θ , α , n ) + {w}_{2} {\sum }_{n = 1}^{N} ( \frac{δ}{δ θ} ( \frac{δ}{δ α} ( uncert ( θ , α , n ) ) ) * Gaussian ( γ , σ ) ) \times vis ( θ , α , n )$$

where N is the number of points, w₁ and w₂ are weighting variables, uncert(θ, α, n) is a parameter quantifying uncertainty, and Gaussian(γ, σ) is a gaussian function at radius γ with width σ.

The uncertainty parameter is calculated from

uncert(θ,α,n)=vis(θ,α,n)×(\vec{ray}(θ,α,n)·\vec{norm}(θ,α,n))

where \vec{ray}(θ, α, n) is normalised ray vector from the camera to point n, {right arrow over (norm()}θ, α, n) is the surface normal of point n, and vis(θ, α, n) is a logical visibility matrix.

The first term in the weighted sum defining the quality function is the accuracy parameter. This term quantifies the accuracy to which the visible points can be localised. This term is at a minimum when the object surface is parallel to the optical axis of a particular camera position and is at a maximum when the object surface is normal to the optical axis of a camera position.

The second term in the weighted sum defining the quality function is the occlusion parameter. This term quantifies the rate at which particular points become occluded from particular camera positions and thus ensures such points are captured. The radius of the gaussian donut convolution determines the angle from the point of disappearance that the point should be captured, with the width of the gaussian determining the spread of the angles that are acceptable. The skilled man will appreciate that additional parameters can be added to the quality function in order to better represent the real measurement or to accelerate the process.

Turning now to optimisation analysis, this can be carried out by minimising a cost function, the cost function comprising a weighted sum of calculated terms related to quality, minimum visibility and triangulation. In the particular example discussed herein, the cost function takes the form:

$$Cost = {c}_{1} {\sum }_{k = 1}^{K} {Quality ( {θ}_{k} , {α}_{k} )}^{- 1} + {c}_{2} {\sum }_{n = 1}^{N} M i n V i s ( n ) + {c}_{3} {\sum }_{n = 1}^{N} Triang ( n )$$

where C₁, c₂ and c₃ are weighting variables, and K is the number of camera positions. The first term in the cost function is a quality term calculated from a sum of the quality function over selected camera positions.

The second term in the cost function is a minimum visibility term. This term relates to ensuring that each point n is visible in from at least a minimum number of camera positions. This term is calculated from

$$MinVis ( n ) = \{ \begin{matrix}1 , {\sum }_{k = 1}^{K} ν i s ( {θ}_{k} , {α}_{k} , n ) < r e q V i e w \\ 0 , {\sum }_{k = 1}^{K} ν i s ( {θ}_{k} , {α}_{k} , n ) \geq r e q V i e w\end{matrix}$$

where reqView is the minimum number of camera positions.

The third term in the cost function is a triangulation term. This term quantifies how accurately each point n will be triangulated. Effectively, this term maximises the angle between the camera positions in which a point n is visible. This term can be calculated from:

$$Triang ( n ) = {\sum }_{k = 1}^{K - 1} {\sum }_{l = k + 1}^{K} ( \vec{ray} ( {θ}_{k} , {α}_{k} , n ) \cdot \vec{ray} ( {θ}_{l} , {α}_{l} , n ) ) ⨯ common ( k , l , n )$$

where common(k, l, n) is a triangular logical matrix which is 1 when point n is visible in both cameras k and l. common(k, l, n) is defined as:

common(k,l,n)=vis(θₖ,αₖ,n)·vis(θₗ,αₗ,n)

The optimisation analysis may be carried out with respect to a temporal budget or a geometric budget. This can allow an operator to optimise camera positions either for desired maximum scan time or for a desired level of accuracy.

If optimisation analysis is carried out with respect to a temporal budget, an operator can specify a desired maximum scan time or reconstruction time available for photogrammetric analysis. The temporal budget will effectively define the maximum number of images of the object that can be captured during the analysis. In such instances, refinement of initial camera positions determined in relation to the quality function by minimisation of the cost function allows maximisation of the scan quality for the permitted number of images.

If optimisation analysis is carried out with respect to a geometric budget, the operator may define criteria relating to the level of accuracy required from the photogrammetric analysis. Geometric budget optimisation analysis then includes the step of determining the proportion of points n that meet or exceed accuracy criteria. In such an example, the accuracy criteria are calculated using the minimum visibility parameter and/or the triangulation parameter. In particular, the accuracy criteria mare satisfied by points where

$$\frac{1}{N} {\sum }_{n = 1}^{N} MinVis ( n ) < Threshold \% ,$$

where Threshold % is the threshold for non-visible points.

In another implementation, the accuracy criteria may be satisfied by points where

$$\frac{1}{N} {\sum }_{n = 1}^{N} ( Triang ( n ) > ω )$$

where ω is a threshold value. The threshold value ω is be determined by a computational model of the photogrammetry system and may correspond to the Triang(n) value required to reach the predetermined level of accuracy.

The one or more embodiments are described above by way of example only. Many variations are possible without departing from the scope of protection afforded by the appended claims.

1. A method of determining optimum camera positions for capturing images of an object for photogrammetry analysis, the method comprising the steps of: providing a three-dimensional (3D) model of the object; generating a model 3D point cloud from the 3D model; defining a radial shell of possible camera positions around the model 3D point cloud; calculating a quality parameter for the possible camera position; selecting a number of camera positions from the possible camera positions in response to the calculated quality parameter.

2. A method as claimed in claim 1 wherein the method includes the step of providing a model of the camera optics and/or a model of the achievable range of motion of the camera.

3. A method as claimed in claim 1 wherein the shell radius is selected so as to maximise the number of points on the object surface that are in focus.

4. A method as claimed in claim 1 wherein the method utilises more than one shell.

5. A method as claimed in claim 1 wherein the quality parameter is calculated by a quality function comprising a weighted summation of one or more calculated terms.

6. A method as claimed in claim 5 wherein one or more of the calculated terms involves calculation of an uncertainty parameter uncert(θ, α, n) for a point n from
uncert(θ,α,n)=vis(θ,α,n)×(\vec{ray}(θ,α,n)·\vec{norm}(θ,α,n))
where θ is the azimuth, α is the elevation, \vec{ray}(θ, α, n) is a normalised ray vector from the camera to point n, \vec{norm}(θ, α, n) is the surface normal of point n and vis(θ, α, n) is a logical visibility matrix.

7. A method as claimed in claim 6 wherein one calculated term is an accuracy parameter calculated from
$${\sum }_{n = 1}^{N} u n c e r t ( θ , α , n )$$
where N is the number of points

8. A method as claimed in claim 6 wherein one calculated term is an occlusion parameter calculated from
$${\sum }_{n = 1}^{N} ( \frac{δ}{δθ} ( \frac{δ}{δ α} ( u n c e r t ( θ , α , n ) ) ) ⋆ Gaussian ( γ , σ ) ) ⨯ ν is ( θ , α , n )$$
where Gaussian (γ, σ) is a gaussian function at radius γ with width σ.

9. A method as claimed in claim 6 wherein the quality function used for calculating the quality parameter (Quality(θ, α)) is defined by
$$Quality ( θ , α ) = {w}_{1} {\sum }_{n = 1}^{N} uncert ( θ , α , n ) + {w}_{2} {\sum }_{n = 1}^{N} ( \frac{δ}{δθ} ( \frac{δ}{δ α} ( u n c e r t ( θ , α , n ) ) ) ⋆ Gaussian ( γ , σ ) ) ⨯ ν is ( θ , α , n )$$
where w₁ and w₂ are weighting variables.

10. A method as claimed in claim 6 wherein the method includes the step of selecting initial camera positions using the quality function and subsequently carrying out optimisation analysis to select optimum camera positions.

11. A method as claimed in claim 10 wherein the optimisation analysis is carried out by optimising a cost function, the cost function comprising a weighted sum of one or more calculated terms.

12. A method as claimed in claim 11 wherein one calculated term is a quality term calculated from
$${\sum }_{k = 1}^{K} {Quality ( {θ}_{k} , {α}_{k} )}^{- 1}$$
where K is the number of cameras.

13. A method as claimed in claim 11 wherein one calculated term is a minimum visibility term calculated from
$${\sum }_{n = 1}^{N} MinVis ( n )$$
where is MinVis(n) a minimum visibility parameter defined by:
$$MinVis ( n ) = \{ \begin{matrix}1 , {\sum }_{k = 1}^{K} ν i s ( {θ}_{k} , {α}_{k} , n ) < reqView \\ 0 , {\sum }_{k = 1}^{K} ν i s ( {θ}_{k} , {α}_{k} , n ) \geq reqView\end{matrix}$$
where reqView is the minimum number of camera positions from which each point n must be visible.

14. A method as claimed in claim 11 wherein one calculated term is a triangulation term calculated from
$$Triang ( n ) = {\sum }_{k = 1}^{K - 1} {\sum }_{l = k + 1}^{K} ( \vec{ray} ( {θ}_{k} , {α}_{k} , n ) \cdot \vec{r a y} ( {θ}_{l} , {α}_{l} , n ) ) ⨯ common ( k , l , n )$$
where common(k,l,n) is a triangular logical matrix which is 1 when point n is visible in both cameras k and l.

15. A method as claimed in claim 14 wherein the triangular logical matrix is calculated from
common(k,l,n)=vis(θₖ,αₖ,n)·vis(θₗ,αₗ,n)

16. A method as claimed in claim 11 wherein the cost function is defined by
$$Cost = {c}_{1} {\sum }_{k = 1}^{K} Q u a l i t {y ( {θ}_{k} , {α}_{k} )}^{- 1} + {c}_{2} {\sum }_{n = 1}^{N} MinVis ( n ) + {c}_{3} {\sum }_{n = 1}^{N} Triang ( n )$$
where c₁, c₂ and c₃ are weighting variables.

17. A method as claimed in claim 11 wherein the optimisation analysis is carried out with respect to a temporal budget defined by the maximum scan time or reconstruction time available for photogrammetric analysis.

18. A method as claimed in claim 17 wherein the temporal budget optimisation analysis includes the step of selecting a preset number of initial camera positions and refining the initial camera positions by minimisation of the cost function.

19. A method as claimed in claim 11 wherein the optimisation analysis is carried out with respect to a geometric budget defined by the level of accuracy required from the photogrammetric analysis.

20. A method as claimed in claim 19 wherein the geometric budget optimisation analysis includes the step of determining the proportion of points n that meet or exceed accuracy criteria.

21. A method as claimed in claim 20 wherein the accuracy criteria are satisfied by points where
$$\frac{1}{N} {\sum }_{n = 1}^{N} MinVis ( n ) < Threshold \%$$
where Threshold % is the threshold for non-visible points.

22. A method as claimed in claim 20 wherein the accuracy criteria are satisfied by points where
$$\frac{1}{N} {\sum }_{n = 1}^{N} ( Triang ( n ) > ω )$$
where ω is a threshold value.

23. A method as claimed in claim 22 wherein the threshold value ω is determined by a computational model of the photogrammetry system or by a model of the camera optics.

24. A photogrammetry apparatus comprising: one or more cameras, each camera provided on a movable mounting bracket; an analysis engine operable to conduct photographic analysis of images captured by the or each camera; and a camera position engine operable to calculate optimum camera positions for capturing images of an object for photogrammetry analysis, the camera position engine operable according to the method of claim 1.
